(19) United States
(12) Patent Application Publication
(10) Pub. No.: US 2012/0186268 A1
(43) Pub. Date: Jul. 26, 2012

(54) CONTROL OF THE GAS COMPOSITION IN A GAS TURBINE POWER PLANT WITH EXHAUST GAS RECIRCULATION

(75) Inventors: Stefan ROFKA, Nussbaumen (CH); Juergen HOFFMANN, Untersiggenthal (CH); Eribert BENZ, Birmenstorf (CH); Frank SANDER, Rieden (CH); Martin NICKLAS, Wettingen (CH)

(73) Assignee: ALSTOM TECHNOLOGY LTD, Baden (CH)

(21) Appl. No.: 13/355,491

(22) Filed: Jan. 21, 2012

(30) Foreign Application Priority Data
Jan. 24, 2011 (CH) 00116/11

(51) Int. Cl. F02C 9/16; F02C 6/04

(52) U.S. Cl. 60/783; 60/39.182

(57) ABSTRACT

A method is provided for operating a gas turbine power plant with exhaust gas recirculation, in which, based upon the operating state of the gas turbine a setpoint concentration of at least one constituent in an exhaust gas flow and/or in the intake flow of the gas turbine after adding the recirculated exhaust gases is determined. The actual concentration of the at least one constituent in the exhaust gas flow and/or in the intake flow is measured and a control element for controlling the recirculation flow is controlled based upon the setpoint/actual deviation. Also provided is a gas turbine power plant with exhaust gas recirculation and includes a controller, in which a setpoint concentration of at least one constituent in an exhaust gas flow or in the intake flow of the gas turbine is determined, and a measuring instrument for measuring the actual concentration of the at least one constituent.

### RELATED APPLICATION

The present application hereby claims priority under 35 U.S.C. Section 119 to Swiss Patent application number 00116/11, filed Jan. 24, 2011, the entire contents of which are hereby incorporated by reference.

### FIELD OF INVENTION

The present invention refers to a method and system for controlling the gas composition of a gas turbine with exhaust gas recirculation.

### BACKGROUND

The recirculation of exhaust gases is a technology which can be used basically for the most diverse purposes in gas turbines, such as for the control of emissions, for reducing the exhaust gas volume, for carbon dioxide separation, etc. During the recirculation of exhaust gases in a gas turbine, an essential proportion of the exhaust gas is tapped from the overall exhaust gas flow and, after cooling and scrubbing, is normally fed again to the inlet mass flow of the turbine or to the compressor of the turbine, wherein the recirculated exhaust gas flow is mixed with fresh air, and this mixture is then fed to the compressor.

As a result of exhaust gas recirculation, the carbon dioxide partial pressure in the exhaust gases can advantageously be increased in order to reduce the power losses and efficiency losses of power plants with carbon dioxide separation. Furthermore, exhaust gas recirculation has been proposed with the aim of reducing the oxygen concentration in the intake gases of gas turbines in order to reduce the NOx emissions as a result.

For exhaust gas recirculation, U.S. Pat. No. 7,536,252 B1, for example, describes a method for controlling an exhaust gas recirculation flow of a turbomachine which is fed back to the inlet of the turbomachine via an exhaust gas recirculation system. With this method, a setpoint exhaust gas recirculation proportion, which contains the proportion of the exhaust gas flow in the inlet flow of the turbomachine, is determined, and the actual value is adjusted to the setpoint value.

A power plant with exhaust gas recirculation and also a method for operating such a power plant, in which based upon load the recirculation rate and the temperature to which the recirculated exhaust gases are recooled are controlled, is known from EP2248999. This publication, as well as other known publications, uses, or use, a recirculation rate, i.e. the ratio of recirculated exhaust gas to intake mass flow of the turbomachine or the proportion of recirculated exhaust gas in the intake mass flow of the turbomachine. In practice, the problem of reliably determining the proportion or the ratio presents itself in the case of the said methods. Both the intake mass flow and the recirculation mass flow can only be measured with large outlay and without any accuracy.

### SUMMARY

The present disclosure is directed to a method for operating a gas turbine power plant with exhaust gas recirculation. The plant includes a gas turbine, a heat recovery steam generator and an exhaust gas splitter which splits the exhaust gases into a first exhaust gas flow for recirculation into an intake flow of the gas turbine and into a second exhaust gas flow for discharging to the environment, and a control element for controlling the first exhaust gas flow. The method includes determining a setpoint concentration of at least one constituent in an exhaust gas flow and/or in the intake flow of the gas turbine after adding the recirculated exhaust gases based upon an operating state of the gas turbine. The method also includes measuring an actual concentration of the at least one constituent in the exhaust gas flow and/or in the intake flow; and using the control element to control the first exhaust gas flow based upon a setpoint actual deviation.

In another aspect, the present disclosure is directed to a gas turbine power plant with exhaust gas recirculation, including a gas turbine with a controller, a heat recovery steam generator and an exhaust gas splitter which splits the exhaust gases into a first exhaust gas flow for recirculation into an intake flow of the gas turbine and into a second exhaust gas flow for discharging to the environment, and a control element for controlling the first exhaust gas flow. In the controller a setpoint concentration of at least one constituent, in an exhaust gas flow and/or in the intake flow of the gas turbine after adding the recirculated exhaust gases, is determined as a function of an operating state, and comprises a measuring instrument for measuring an actual concentration of this at least one constituent in the exhaust gas flow and/or in the intake flow after adding the first exhaust gas flow.

### BRIEF DESCRIPTION OF THE DRAWINGS

Preferred embodiments of the invention are described in the following text with reference to the drawings which serve purely for explanation and are not to be considered as being limiting. In the drawings:

FIG. 1 shows a schematic view of a gas turbine power plant with recirculation of the exhaust gases; and

FIG. 2 schematically shows the curves of inlet pressure loss, exhaust gas pressure loss, the pressure difference for recirculation and the carbon dioxide concentration at the compressor inlet of a gas turbine over time after a load shedding.

### DETAILED DESCRIPTION OF THE PREFERRED EMBODIMENTS

### Introduction to the Embodiments

The present invention is based on the object of disclosing a method for the reliable operation of a gas turbine power plant with exhaust gas recirculation and control of the said exhaust gas recirculation.

According to the invention, this object is achieved by means of the subject of the independent claims. According to the invention, a method is provided in which a content or a concentration (molar concentration or mass concentration) of at least one constituent of a gas flow of the gas turbine process is used directly for controlling an actuating element for the exhaust gas recirculation.

In this method for operating a gas turbine power plant with exhaust gas recirculation—which comprises a gas turbine, a heat recovery steam generator and an exhaust gas splitter which splits the exhaust gases into a first exhaust gas flow for recirculation into an intake flow of the gas turbine, and into a second exhaust gas flow for discharge to the environment, and also a control element for controlling the recirculation flow—a setpoint concentration of at least one constituent in an exhaust gas flow and/or in the intake flow of the gas turbine after adding the recirculated exhaust gases is determined based upon the operating state of the gas turbine. Furthermore, the actual concentration of this at least one constituent in the exhaust gas flow and/or in the intake flow is measured and the control element for controlling the recirculation flow is controlled based upon the setpoint actual deviation.

In one embodiment of the method, the oxygen concentration in an exhaust gas flow is controlled by the actuating element. In this case, the concentration in the first exhaust gas flow, which is recirculated, the concentration in the second exhaust gas flow, which is discharged to the environment, or the concentration of the exhaust gas flow upstream of the tapping of the recirculation flow, can be controlled.

In an alternative embodiment of the method, the carbon dioxide concentration in one of the exhaust gas flows is controlled. Furthermore, controlling of carbon dioxide concentration and oxygen concentration can be carried out.

According to a further embodiment of the method, the oxygen concentration in the intake flow of the gas turbine after adding the recirculated exhaust gases is controlled.

In another alternative embodiment of the method, the carbon dioxide concentration in the intake flow of the gas turbine after adding the recirculated exhaust gases is controlled. Furthermore, controlling hydrocarbon concentration and oxygen concentration in the intake flow of the gas turbine after adding the recirculated exhaust gases can be carried out.

In the cases in which a control of oxygen concentration and carbon dioxide concentration is provided, a weighting of the two control parameters is advantageous since two parameters are influenced by only one manipulated variable. For example, oxygen concentration and carbon dioxide concentration can be equally weighted. In another example, in order to ensure a complete combustion, the oxygen concentration can be weighted two or three times as much, for example, as the carbon dioxide concentration.

In principle, the oxygen concentration and the carbon dioxide concentration are coupled together. Controlling both parameters is advantageous, for example, if the fuel composition, especially the hydrogen content of the fuel, is altered, or if oxygen is added to the combustible gases.

Furthermore, a combination of controlling the oxygen concentration and/or carbon dioxide concentration in an exhaust gas flow and the concentration in the intake flow of the gas turbine after adding the recirculated exhaust gases is proposed. For this method, a weighting of the two control parameters is advantageous since two or more parameters are influenced by only one controlled variable.

In a further embodiment, a setpoint concentration is determined as a function of the power output of the gas turbine power plant. Instead of the power output, a dependency upon another important operating parameter, or upon a combination of operating parameters, such as the turbine inlet temperature (for example according to ISO 2314), the hot gas temperature, the turbine exhaust temperature, the compressor discharge pressure or the position of the variable compressor inlet guide vanes, can also be used. Furthermore, the setpoint concentration can be determined as a function of the ambient conditions, especially of the ambient temperature or the compressor inlet temperature. In this case, the setpoint concentration is a function of one of, or a combination of, the said parameters, for example.

The maximum exhaust gas recirculation is often restricted because of the oxygen concentration which is required for a stable, complete combustion. A stable, complete combustion in this context means that the CO (carbon monoxide) emissions and UHC (unburned hydrocarbon) emissions remain below the permissible limit values, and that the combustion chamber pulsations remain within the permissible range. The permissible CO emissions and UHC emissions are typically in the order of magnitude of ppm (mostly in the single-digit ppm range). The pulsations, which in the absence of oxygen, can rise with a steep gradient, should remain below 10% of the combustion chamber pressure. They remain typically below 1 to 2% of the combustion chamber pressure. With increase of the CO emissions, the UHC emissions or the combustion chamber pulsations above a limit value, the first exhaust flow is readjusted by means of the control element. For example, the first exhaust gas flow is reduced as soon as a limit value of the CO emissions, of the UNC emissions or of the combustion chamber pulsations is exceeded.

In one embodiment of the method, the setpoint concentration of carbon dioxide or oxygen is corrected as a function of the CO emissions, of the UHC emissions or of the combustion chamber pulsations, or of a combination of two or all three parameters.

In a further advantageous method, the recirculated exhaust gases are cooled to a recooled temperature in an exhaust gas recooler, wherein the recooled temperature is determined as a function of the power output. Instead of the power output, a dependency upon another important operating parameter, or upon a combination of operating parameters, such as the turbine inlet temperature, the hot gas temperature, the turbine exhaust temperature, the compressor discharge pressure or the position of the variable compressor inlet guide vanes, can also be used. Furthermore, the recooled temperature can be determined as a function of the ambient conditions, especially of the ambient temperature. In this case, the recooled temperature is a function of one or of a combination of the said parameters, for example.

In order to ensure a stable, fast controlling of the composition of the intake flow of the gas turbine, it is further proposed that the intake pressure loss between the environment and the adding of the recirculated exhaust gases to the intake flow of the gas turbine and the exhaust gas pressure loss between the exhaust gas splitter and the environment are measured in order to determine therefrom the pressure difference which is available, without additional exhaust gas blowers or boosters for exhaust gas recirculation, between the exhaust gas splitter and the adding of recirculated exhaust gas. Alternatively, the pressure difference between the exhaust gas splitter and the position of adding the exhaust gases to the intake flow of the gas turbine can also be directly measured. The controlling of the control element is corrected based upon the pressure difference.

This control correction is advantageous during transient operation of the gas turbine, especially during fast transients, since by closing the variable compressor inlet guide vanes, for example, the intake mass flow is reduced. As a result, the intake pressure losses, and also the pressure losses across the intake filter, become less and the negative pressure upstream of the inlet of the gas turbine becomes less. At the same time, the exhaust gas pressure losses, such as the pressure losses across a carbon dioxide separation system which is connected downstream to the gas turbine, decrease with the reduced mass flow. These pressure losses change between partial load and full load by a factor of 2 to 3. At full load, the sum of these two pressure losses is typically in the order of magnitude of 30 to 50% of the pressure difference required for the exhaust gas recirculation so that changes in the differential pressure with an unaltered setting of the control element lead to significant changes in the recirculation flow and therefore in the composition of the intake flow and in the composition of the exhaust gas flow. Recirculation systems which operate entirely without additional exhaust gas blowers and only with the pressure difference are furthermore conceivable. These systems correspondingly react more sensitively to changes of the pressure difference.

In one embodiment of the method, a controllable exhaust gas blower is used as the control element for controlling the recirculation flow. The output of the exhaust gas blower can be controlled as a function of the pressure difference between the exhaust gas splitter and the adding of the exhaust gases to the intake flow of the gas turbine, for example. The output of the exhaust gas blower is typically controlled inversely proportionally to the pressure difference between the exhaust gas splitter and the adding of the exhaust gases to the intake flow of the gas turbine.

In a further embodiment of the method, a flap and/or a valve is used as the control element for controlling the recirculation flow. The opening of the flap in the passage direction for the exhaust recirculation, or the opening of the valve inversely proportionally to the pressure difference between the exhaust gas splitter and the adding of the exhaust gases to the intake flow of the gas turbine, is typically controlled. In this case, the exhaust gas splitter itself can also be constructed as the control element, for example as a flap.

Additionally proposed is the combination of a control method in which a controllable exhaust gas blower and a flap and/or a valve are used as control elements for controlling the recirculation flow based upon the pressure difference between the exhaust gas splitter and the adding of the exhaust gases to the intake flow of the gas turbine.

On account of the large volumes of the recirculation lines, of the heat recovery boiler, of recoolers or heat exchangers, which typically lie between a measuring point for determining a concentration of at least one constituent of the exhaust gas flow and the inlet of the gas turbine, and the moderate flow velocities in these volumes for reduction of the pressure losses, a certain time span elapses between the moment at which the gases with a determined concentration of a constituent flows past a measuring point and the moment at which these gases reach the inlet of the gas turbine. Based upon the position of the measuring point, upon the power plant arrangement and upon the operating point, the time span can amount to a few seconds to several minutes. In order to ensure stable controlling, it is advantageous to take this time span into account in the controlling. For this, in an embodiment of the method, the controlling of the control element operates with a time delay which is proportional to the time which the exhaust gases require from the measuring point of the gas composition to entry into the gas turbine (6).

In order to take into account the influence of the operating state of the gas turbine upon the time delay, in a further embodiment of the method the time delay is proportional to the power output of the gas turbine and/or to the position of the variable compressor guide vanes.

In one embodiment, exhaust gas recirculation is carried out in order to provide an oxygen-deficient intake gas for the gas turbine for reducing the NOx emissions. In a further embodiment, an oxygen-deficient intake gas is provided for the gas turbine as a result of the exhaust gas recirculation in order to be able to stably combust a hydrogen-rich combustible gas. In yet another method, the second exhaust gas flow, before discharging to the environment, is directed through a carbon dioxide separation system and carbon dioxide is separated from the second exhaust gas flow. By means of this method, an exhaust gas flow is delivered to the carbon dioxide separation system with a controlled, high carbon dioxide concentration, as a result of which the power output losses and efficiency losses of the entire power plant as a result of the carbon dioxide separation are minimized.

In addition to the method, a gas turbine power plant for implementing the method with exhaust gas recirculation is a subject of the invention. Such a power plant comprises a gas turbine with a controller, a heat recovery steam generator and an exhaust gas splitter which splits the exhaust gases into a first exhaust gas flow for recirculation into an intake flow for the gas turbine and into a second exhaust gas flow for discharging to the environment, and also comprises a control element for controlling the first exhaust gas flow. In this power plant, in the controller, a setpoint concentration of at least one constituent in an exhaust gas flow and/or in the intake flow of the gas turbine after adding the recirculated exhaust gases is determined as a function of the operating state, and comprises a measuring instrument for measuring the actual concentration of this at least one constituent in the exhaust gas flow and/or in the intake flow after adding the first exhaust gas flow. The dependency of the setpoint concentration upon the operating state of the gas turbine can be presented by means of functions or tables, for example.

According to one embodiment of the gas turbine power plant, the power plant comprises a pressure difference measuring device between the exhaust gas splitter and the position of adding the exhaust gases to the intake flow of the gas turbine. Alternatively, the gas turbine power plant comprises an intake pressure loss measuring device which measures the pressure loss between the environment and the position of adding recirculated exhaust gases to the intake flow of the gas turbine, and an exhaust gas pressure loss measuring device which measures the pressure loss between the exhaust gas splitter and the environment. From the sum of the two pressure losses, the pressure difference for the exhaust gas recirculation is determined.

All the explained advantages are applicable not only in the respectively disclosed combinations, but also in other combinations or alone without departing from the scope of the invention. For example, instead of using an exhaust gas blower a booster can be provided. The controlling of the control element has been generally described for the sake of simplification. This is representative for closed-loop controlling or open-loop controlling. Different control strategies, such as two-point controlling, controlling with proportional controllers, with integral controllers or with IP controllers, are known to the person skilled in the art.

### DETAILED DESCRIPTION

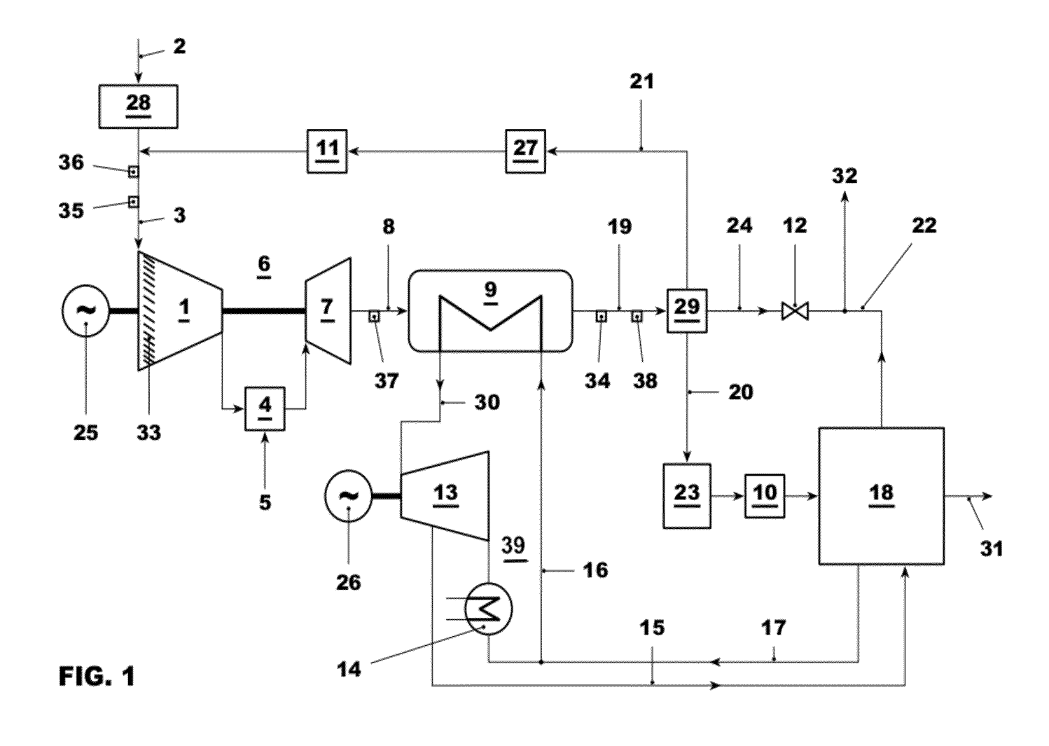

FIG. 1 shows in a schematic view the essential elements of a gas turbine power plant. The gas turbine 6 comprises a compressor 1, the combustion air which is compressed therein being fed to a combustion chamber 4 and combusted with fuel 5. The hot combustion gases are then expanded in a turbine 7. The useful energy which is generated in the turbine 7 is then converted into electric power by a first generator 25, for example, which is arranged on the same shaft.

The hot exhaust gases 8 which issue from the turbine 7, for optimum utilization of the energy which is still contained therein, are used in a heat recovery steam generator 9 (HRSG) for producing live steam 30 for a steam turbine 13 or for other plants. The useful energy which is generated in the steam turbine 13 is then converted into electric power by a second generator 26, for example, which is arranged on the same shaft. The water-steam cycle 39 is simplified in the example and shown only schematically with a condenser 14 and feed water line 16. Different pressure stages, feed water pumps, etc., are not shown since these are not the subject of the invention.

Some of the exhaust gases 19 from the heat recovery steam generator, downstream of the heat recovery steam generator 9 in such a plant, are split into a first exhaust gas partial flow 21 and a second exhaust gas partial flow 20 in a flow splitter 29 which can be controlled. The first exhaust gas partial flow 21 is fed back into the intake line of the gas turbine 6 and mixed with ambient air 2 there. The second exhaust gas partial flow 20, which is not fed back, is typically further cooled in an exhaust gas recooler 23 and fed to a carbon dioxide separation system 18. From this, carbon dioxide-deficient exhaust gases 22 are discharged to the environment via an exhaust stack 32. In order to overcome the pressure losses of the carbon dioxide separation system 18 and of the exhaust gas line, an exhaust gas blower 10 can be provided. The carbon dioxide 31 which is separated in the carbon dioxide separation system 18 is typically compressed in a compressor and discharged for storage or for further treatment. The carbon dioxide separation system 18, via a steam extraction line 15, is supplied with steam, typically intermediate-pressure or low-pressure steam, which is tapped from the steam turbine 13. The steam is fed back again to the water-steam cycle after energy release in the carbon dioxide separation system 18. In the depicted example, the steam is condensed and added to the feed water via the condensate return line 17.

The second exhaust gas partial flow can also be guided directly via an exhaust gas bypass 24 to the exhaust stack 32.

The fed back exhaust gas flow 21 is cooled to just above ambient temperature in an exhaust gas recooler 27 which can be equipped with a condenser. Downstream of this exhaust gas recooler 27, a booster or exhaust gas blower 11 can be arranged for the recirculation flow 21. This fed back exhaust gas flow 21 is mixed with the ambient air 2 before the mixture is fed as intake flow to the gas turbine 6 via the compressor inlet 3. The fresh ambient air 2 in this case is first directed via an air filter 28 with a large inlet cross section before the recirculated exhaust gases 21 are added.

The intake flow of the gas turbine 6 is controlled via the variable compressor inlet guide vanes 33. The intake flow and the resulting exhaust gas flow basically determine the intake pressure loss Δpᵢₙ between the environment and the adding of the recirculated exhaust gases to the intake flow of the gas turbine 6 and the exhaust gas pressure loss Δpₒᵤₜ between the exhaust gas splitter 29 and the environment. The pressure difference between these two positions has a significant influence upon the amount of recirculated exhaust gases. For a faster and more accurate control, the intake pressure loss Δpᵢₙ between the environment and the adding of the recirculated exhaust gases to the intake flow is measured by the intake pressure measuring device 35 and the exhaust gas pressure loss Δpₒᵤₜ between the exhaust gas splitter 29 and the environment is measured by the exhaust gas pressure measuring device 34. The measured pressure differences are transmitted to the controller (controller and measurement lines not shown). The influence of the pressure difference Δpᵣₑₛ upon the recirculated first exhaust gas partial flow 21 is approximated in the controller and the output of the exhaust gas blower 11 is adjusted and/or the position of the exhaust gas splitter 29 is adjusted in order to take into account the changes in the pressure difference Δpᵣₑₛ. The controller and the exhaust gas blower 11 are connected via the signal exchange to the exhaust gas blower for exhaust gas recirculation. The controller and the exhaust gas splitter 29 are connected via the signal exchange to the exhaust gas splitter.

Instead of the pressure measuring devices 34, 35, the pressure difference Δpᵣₑₛ can be measured directly or the pressure difference Δpᵣₑₛ can be approximated as a function of the position of the variable compressor inlet guide vanes 33.

In order to be able to control the concentration of oxygen in the inlet flow of the gas turbine 6, this is measured by the inlet flow oxygen measuring device 36. In the depicted example, provision is additionally made for an exhaust gas flow oxygen measuring device 37. On account of the thorough mixing-through of the exhaust gas flow in the exhaust gas ducts and in the heat recovery boiler 9, an exhaust gas flow oxygen measurement 38 downstream of the heat recovery boiler can be accurately carried out with only one measuring probe, or with a few measuring probes. On account of the large volumes, the exhaust gas composition of the gas turbine, however, is first measured with a time delay, which during transient operation of the gas turbine 6 can lead to control errors. In one embodiment, therefore, the exhaust gas flow oxygen measuring device downstream of the heat recovery boiler 38 is used for steady-state operation and during transient operation an exhaust gas flow oxygen measuring device 37 directly downstream of the exhaust from the turbine 7, or the inlet flow oxygen measuring device 36, is used.

Alternatively, or in combination, an inlet flow carbon dioxide measuring device 36 or an exhaust gas flow carbon dioxide measuring device 37 and/or an exhaust gas flow carbon dioxide measuring device downstream of the heat recovery boiler 38 can also be provided.

In the depicted example, the controller controls the gas turbine via the signal exchange to the said gas turbine. Furthermore, in the depicted example the water-steam cycle is controlled via the signal exchange to the said water-steam cycle and the carbon dioxide separation system is controlled via the signal exchange to the said carbon dioxide separation system.

Alternatively, the individual main components of the power plant, i.e. the gas turbine, the steam turbine and the carbon dioxide separation system, have separate controllers which intercommunicate or are controlled by a master controller. This master controller is then the controller, the component controllers not being shown.

The example shows a gas turbine 6 with a single combustion chamber 4. The invention can also be used without limitation for gas turbines with sequential combustion, as shown in U.S. Pat. No. 5,634,327, the contents of which are incorporated by reference.

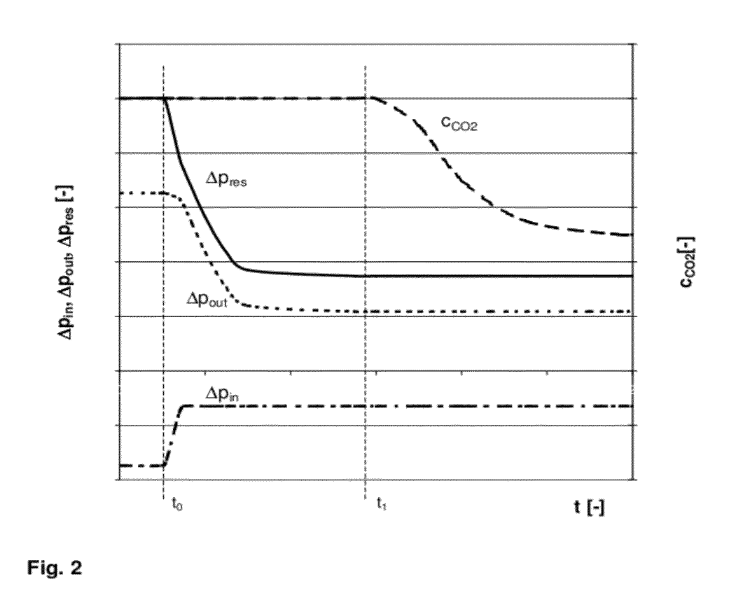

The curve of the intake pressure loss Δpᵢₙ between the environment and the location of adding the recirculated exhaust gases to the intake flow of the gas turbine 6 and the exhaust gas pressure loss Δpₒᵤₜ between the exhaust gas splitter 29 and the environment, and also the resulting pressure difference Δpᵣₑₛ between the intake pressure loss Δpᵢₙ and the exhaust gas pressure loss Δpₒᵤₜ over time t, is shown non-dimensionally in FIG. 2 for a load shedding as an example of a fast transient. The pressure losses and difference in this case are normalized with the resulting pressure difference at full load. In the example, the load of the gas turbine is shed at a time point t0, i.e. the generator 25 is disconnected from the grid. As a reaction to the load shedding, the controller closes the variable compressor inlet guide vanes 33, as a result of which the intake flow is reduced and the intake pressure loss Δpᵢₙ is reduced accordingly. On account of the large volumes of the heat recovery steam generator 9, of the exhaust gas lines and of the carbon dioxide separation system 18, the exhaust gas pressure loss Δpₒᵤₜ between the exhaust gas splitter 29 and the environment falls with a slight delay.

Furthermore, in FIG. 2 the curve of the inlet flow carbon dioxide concentration over time t is shown. Also, if the carbon dioxide concentration of the hot exhaust gases 8 of the gas turbine becomes less after the load shedding practically without a time delay, the carbon dioxide concentration in the inlet flow, under the assumption that the recirculation ratio remains constant, initially remains constant up to time point t1. Only with a significant time delay in the order of magnitude of 0.5 to 3 minutes does the carbon dioxide concentration in the inlet flow begin to fall.

Corresponding to the changing pressure ratios, the controller must first adjust the position of the exhaust gas splitter 29 or adjust the output of the exhaust gas blower for the first exhaust gas partial flow 11. As soon as the exhaust gases with altered carbon dioxide concentration reach the inlet of the gas turbine 6, the controller, for compensation, must adjust the position of the exhaust gas splitter 29 or additionally adjust the output of the exhaust gas blower for the first exhaust gas partial flow 11.

### LIST OF DESIGNATIONS

1 Compressor
2 Ambient air
3 Compressor inlet
4 Combustion chamber
5 Fuel
6 Gas turbine
7 Turbine
8 Hot exhaust gases of the gas turbine
9 Heat recovery steam generator (HRSG)
10 Exhaust gas blower for the second exhaust gas partial flow (for the carbon dioxide separation system)
11 Exhaust gas blower for the first exhaust gas partial flow (exhaust gas recirculation)
12 Bypass flap or valve
13 Steam turbine
14 Condenser
15 Steam extraction for the carbon dioxide separation system
16 Feed water line
17 Condensate return line
18 Carbon dioxide separation system
19 Exhaust gas from the heat recovery steam generator
20 Second exhaust gas partial flow (exhaust gas line to the carbon dioxide separation system)
21 First exhaust gas partial flow (exhaust gas recirculation)
22 Carbon dioxide-deficient exhaust gas
23 Exhaust gas recooler (for the second exhaust gas partial flow)
24 Exhaust gas bypass to the exhaust stack
25 First generator
26 Second generator
27 Exhaust gas recooler (for the first exhaust gas partial flow)
28 Filter
29 Exhaust gas splitter
30 Live steam
31 Separated carbon dioxide
32 Exhaust stack
33 Variable compressor inlet guide vanes
34 Exhaust gas pressure measuring device
35 Inlet pressure measurement
36 Inlet flow carbon dioxide and/or oxygen measuring device
37 Gas turbine exhaust gas carbon dioxide and/or oxygen measuring device
38 Heat recovery steam generator-exhaust gas carbon dioxide and/or oxygen measuring device
39 Water-steam cycle
C_{CO2} Carbon dioxide concentration
Δpᵢₙ Intake pressure loss
Δpₒᵤₜ Exhaust gas pressure loss
Δpᵣₑₛ Pressure difference
t Time
t₀ Starting time point of a transient

What is claimed is:

1. A method for operating a gas turbine power plant with exhaust gas recirculation, comprising a gas turbine (6), a heat recovery steam generator (9) and an exhaust gas splitter (29) which splits the exhaust gases (19) into a first exhaust gas flow (21) for recirculation into an intake flow of the gas turbine (6) and into a second exhaust gas flow (20) for discharging to the environment, and a control element (11, 29) for controlling the first exhaust gas flow (21), the method comprising:
determining a setpoint concentration of at least one constituent in an exhaust gas flow and/or in the intake flow of the gas turbine after adding the recirculated exhaust gases based upon an operating state of the gas turbine;
measuring an actual concentration of the at least one constituent in the exhaust gas flow and/or in the intake flow; and
using the control element (11, 29) to control the first exhaust gas flow (21) based upon a setpoint actual deviation.

2. The method as claimed in claim 1, wherein an oxygen concentration and/or a carbon dioxide concentration in an exhaust gas flow and/or in the intake flow of the gas turbine, after adding the recirculated exhaust gases, is controlled.

3. The method as claimed in claim 1, wherein the setpoint concentration is determined as a function of a power output and/or of ambient conditions.

4. The method as claimed in claim 3, wherein the recirculated exhaust gases are cooled to a recooled temperature in an exhaust gas recooler (27), the recooled temperature is determined as a function of the power output and/or of the ambient conditions.

5. The method as claimed in claim 1, wherein an intake pressure loss (Δpᵢₙ) between the environment and the adding of the recirculated exhaust gases to the intake flow of the gas turbine (6) and an exhaust gas pressure loss (Δpₒᵤₜ) between the exhaust gas splitter (29) and the environment are measured in order to determine therefrom a pressure difference (Δpᵣₑₛ) for the exhaust gas recirculation and/or the pressure difference (Δpᵣₑₛ) between the exhaust gas splitter (29) and the adding of the exhaust gases to the intake flow of the gas turbine (6) is directly measured and the controlling of the control element (11, 29) is corrected based upon the pressure difference (Δpᵣₑₛ).

6. The method as claimed in claim 1, wherein a controllable exhaust gas blower (11) is used as the control element for controlling the recirculation flow.

7. The method as claimed in claim 6, wherein the output of the exhaust gas blower (11) is increased inversely proportionally to the pressure difference (Δpᵣₑₛ) between the exhaust gas splitter (29) and the admixture of the recirculated first exhaust gas flow (21).

8. The method as claimed in claim 1, wherein a flap (29) and/or a valve is used as the control element for controlling the recirculation flow.

9. The method as claimed in claim 8, wherein an opening of the flap in the passage direction for exhaust gas recirculation, or an opening of the valve inversely proportionally to the pressure difference (Δpᵣₑₛ) between the exhaust gas splitter (29) and the adding of the exhaust gases to the intake flow of the gas turbine (6), is increased.

10. The method as claimed in claim 1, wherein a controlling of the control element operates with a time delay which is proportional to a time which the exhaust gases require from the measuring point of the gas composition to entry into the gas turbine (6).

11. The method as claimed in claim 10, wherein the time delay is proportional to a power output of the gas turbine (6) and/or to a position of the variable compressor inlet guide vanes (33).

12. The method as claimed in claim 1, wherein the second exhaust gas flow (20), before discharging to the environment, is directed through a carbon dioxide separation system (18) and carbon dioxide is separated from the second exhaust gas flow (20).

13. The method as claimed in claim 1, wherein the recirculated first exhaust gas flow is readjusted by the control element (11, 29) based upon carbon monoxide emissions, unburned hydrocarbon emissions and/or combustion chamber pulsations of the gas turbine (6).

14. A gas turbine power plant with exhaust gas recirculation, comprising a gas turbine (6) with a controller, a heat recovery steam generator (9) and an exhaust gas splitter (29) which splits the exhaust gases (19) into a first exhaust gas flow (21) for recirculation into an intake flow of the gas turbine (6) and into a second exhaust gas flow (20) for discharging to the environment, and a control element for controlling the first exhaust gas flow (21), in the controller a setpoint concentration of at least one constituent in an exhaust gas flow and/or in the intake flow of the gas turbine after adding the recirculated exhaust gases is determined as a function of an operating state, and comprises a measuring instrument (36, 37, 38) for measuring an actual concentration of this at least one constituent in the exhaust gas flow and/or in the intake flow after adding the first exhaust gas flow (21).

15. The gas turbine power plant as claimed in claim 14, further comprising a pressure difference measuring device provided between the exhaust gas splitter (29) and a point where the exhaust gases are added to the intake flow of the gas turbine (6) and/or an intake pressure measuring device (35), which measures an intake pressure loss (Δpᵢₙ) between the environment and a point where the recirculated exhaust gases are added to the intake flow of the gas turbine (6), and an exhaust gas pressure measuring device (34), which measures an exhaust gas pressure loss (Δpₒᵤₜ) between the exhaust gas splitter (29) and the environment, are provided in order to determine from a sum of the two pressure losses (Δpᵢₙ, Δpₒᵤₜ) a pressure difference (Δpᵣₑₛ) for exhaust gas recirculation.
